(19) United States
(12) Patent Application Publication
(10) Pub. No.: US 2008/0230093 A1
(43) Pub. Date: Sep. 25, 2008

(54) Apparatus, Vehicle and Method For Cleaning Surfaces Fouled With Chewing Gum

(75) Inventor: Abram Evert Van Laar, Valburg (NL)

Correspondence Address: THE WEBB LAW FIRM, P.C., 700 KOPPERS BUILDING, 436 SEVENTH AVENUE, PITTSBURGH, PA, 15219, US

(73) Assignee: JADON, Twijzelerheide (NL)

(21) Appl. No.: 10/586,277

(22) PCT Filed: Jan. 17, 2005
(86) PCT No.: PCT/NL2005/000032

§ 371 Date: Feb. 6, 2008

(30) Foreign Application Priority Data
Jan. 23, 2004 (NL) 1025308

(51) Int. Cl. B08B 3/02; B08B 13/00

(52) U.S. Cl. 134/42; 134/105

(57) ABSTRACT

The invention relates to an apparatus for cleaning diverse types of surface, such as public highways, pavements, squares and so on. The invention also relates to a vehicle for cleaning such surfaces. The invention further relates to a method for cleaning such surfaces.

The invention relates to an apparatus litter for cleaning surfaces fouled with chewing gum, comprising a mobile support structure for: at least one supply container for cleaning agent, a plurality of spray units coupled to the supply container for spraying a surface for cleaning with cleaning agent, wherein each spray unit is adapted to spray the same part-surface at least once during displacement of the support structure, and at least one pump for feeding cleaning agent under pressure to at least one spray unit, wherein at least a front spray unit, as seen in the direction of displacement of the support structure, lies at least substantially in front of another, rear spray unit. The invention also relates to a vehicle for cleaning surfaces fouled with chewing gum, wherein the vehicle is provided with at least one supply container for cleaning agent, a plurality of spray units for spraying a surface for cleaning with the cleaning agent, wherein each spray unit is adapted to spray the same part-surface at least once during displacement of the support structure, and at least one pump for feeding cleaning agent taken up from the supply container under pressure to at least one spray unit, wherein at least a front spray unit, as seen in the direction of displacement of the support structure, lies at least substantially in front of another, rear spray unit. The invention further relates to a method for cleaning surfaces fouled with chewing gum.

Diverse apparatus are known in the prior art which are adapted to clean surfaces. Particularly when the surface is contaminated seriously and/or for a long period, it is generally difficult to remove the fouling from the surface and thus actually clean the surface. Considerable fouling of floor surfaces occurs particularly in public traffic and pedestrian areas. For instance public highways, squares and pavements are thus frequently exposed to deposition (and growth) of all types of fouling, such as for instance chewing gum residues, oil, soot, algae, mosses and so on. Cleaning vehicles are therefore deployed regularly by diverse public agencies to remove the fouling deposited in public traffic and pedestrian areas. During displacement of the vehicle the relevant surface is swept, and optionally sprayed with a liquid, whereby generally a substantial part of the surface is cleaned. An example of such a cleaning vehicle is described in the international patent application WO00/20693. The cleaning vehicle is here adapted to clean surfaces by spraying cleaning liquid at ultra-high pressure (higher than 1400 bar) via a plurality of nozzles in a curvilinear pattern on the surface. In one embodiment the cleaning vehicle is provided with a plurality of rotatable support structures on which a plurality of nozzles are arranged. These support structures can herein be positioned in line in order to cause a part-surface to be sprayed a number of times by each support structure at normal speed of displacement of the vehicle, in order to thus enable the cleaning capacity of the known vehicle to be improved. The known cleaning vehicle is however not generally able to brush loose and/or release by softening all types of persistent adhered dirt, such as determined chewing gum residues and paint residues, in relatively rapid and effective manner so that this dirt can then be removed, this without damage to underlying paving being caused by the ultra-high pressure of the cleaning liquid.

The invention has for its object to provide an improved apparatus for cleaning surfaces fouled with chewing gum, with which persistent fouling residues can also be removed in a relatively short time from a surface for cleaning without herein causing damage to the surface for cleaning.

The invention provides for this purpose an apparatus of the type stated in the preamble, characterized in that the apparatus comprises pressure-generating means for bringing the cleaning agent under pressure such that the pressure of the cleaning agent sprayed on the surface for cleaning fouled with chewing gum lies substantially between 300 and 750 bar, and that the apparatus comprises heating means for heating the cleaning agent such that the temperature of the cleaning agent sprayed on the surface for cleaning fouled with chewing gum amounts to a minimum of 115 degrees Celsius. Owing to the particular combination of spraying a single part-surface a number of times under a somewhat increased pressure of between 300 and 750 bar with a heated cleaning agent at a temperature of at least 115 degrees Celsius, relatively persistent chewing gum residues and the like can be removed in effective manner from a surface without herein causing damage to the cleaned surface. Tests have shown that merely applying a somewhat increased pressure without increasing the temperature of the cleaning agent, or only increasing the temperature of the cleaning agent without increasing the pressure cannot result in effective cleaning of a surface fouled with chewing gum. It has been found from tests that an effective cleaning can take place only in the case the cleaning agent is heated to a temperature of a minimum of 115 degrees Celsius and sprayed with a pressure of a minimum of 300 bar against the surface for cleaning. Conversely, optimal cleaning results can be obtained at a temperature of the cleaning agent amounting preferably to at least 125 degrees Celsius, more preferably about 150 degrees Celsius and at a pressure preferably lying between 350 and 400 bar. The above values for pressure and temperature relate particularly to the values of these quantities at the position of the outflow openings for cleaning agent forming part of the spray units. The cleaning agent is generally formed in substantial part by water. Because the pressure of the cleaning agent leaving the apparatus is increased sufficiently, the formation of steam in the apparatus can be prevented. By applying a plurality of spray units positioned one behind the other, in addition to increasing the pressure and temperature of the cleaning agent, a surface for cleaning is first cleaned a first time by the front spray unit, wherein the fouling is at least partially released by softening, and is subsequently cleaned for a second time by the rear spray unit in order to completely spray off the dirt released (to some extent) by softening, in particular chewing gum, from the surface for cleaning. The increased temperature of the relatively hot cleaning agent will generally result in further softening of the contaminants for removing, in particular chewing gum residues, so as to further increase the efficiency of the apparatus according to the invention. Owing to the dual, successive cleaning, a relatively effective and complete cleaning of surfaces fouled with chewing gum can be achieved in a relatively short time. Each spray unit herein sprays the same part-surface at least once, though preferably a number of times, this subject to, among other things, the speed of displacement of the apparatus, in order to enable maximizing of the total cleaning of the surface. The pressure, temperature and quantity of cleaning agent sprayed onto the surface via the spray units can—depending on the nature and amount of fouling to be removed—vary per spray unit. The cleaning agent will generally be formed by a liquid, in particular water. (Environmentally-friendly) additives can optionally be added to the liquid to improve the surface cleaning. Each spray unit is preferably provided with one or more nozzles which can be of very diverse nature and design. The front spray unit and the rear spray unit will usually lie substantially in line with each other and, as assembly, also lie in line with the direction of displacement of the support structure, so as to enable maximizing of the part-surface cleaned by the two spray units. It is noted that in determined conditions it is also possible to envisage positioning more than two spray units (for instance three) successively as seen in the direction of transport of the support structure. Although the apparatus according to the invention is intended primarily for the removal of chewing gum residues from a surface, it will be apparent that the apparatus will also be able to remove from an underlying surface other types of fouling strongly adhered to the surface, such as for instance road markings and tyre tracks.

In a preferred embodiment, at least some of the number of spray units is adapted to spray the surface for cleaning in a substantially circular spray pattern. A circular spray pattern displacing during transport of the support structure is particularly effective in spraying a relatively large surface area at least once, but preferably a number of times, with a single spray unit. The number of times the part-surface is sprayed depends here on, among other things, the speed of displacement of the apparatus according to the invention during cleaning. The circular spray patterns of the front spray unit and the rear spray unit can partly overlap each other. The substantially circular spray pattern can be created in diverse ways by the spray unit. The spray unit can thus be provided with a spray aperture which extends all-around. The substantially circular spray pattern will generally be formed by one or more rotatable nozzles of the spray unit. For this purpose the spray units are preferably connected rotatably to the support structure. The substantially circular spray pattern can thus also be generated by embodying the spray unit as rotor on which one or more spray nozzles are arranged. The rotation speed of each rotor can preferably be regulated individually here. Each rotor will generally be rotated at a rotation speed between 500 and 1400 revolutions per minute in order to be able to achieve an effective cleaning of the surface fouled with chewing gum. The rotation direction can also be made dependent on the situational conditions. Preferably however, the nozzles are oriented such that the cleaning agent is sprayed on the surface for cleaning in a direction substantially corresponding to the rotation direction in order to be able to generate a thrusting movement of the jet of the cleaning agent and thus enable an effective cleaning of the surface for cleaning to be realized.

In another preferred embodiment, the apparatus is provided with at least two spray sets, each provided with at least two spray units, wherein the spray sets, as seen in the direction of displacement of the support structure, are positioned one behind the other. Diverse configurations of spray units can thus be applied, wherein other spray units are located adjacently of as well as behind or in front of each spray unit. A 2×2, 3×2, or 4×2 configuration of spray units will generally be most applied, wherein each spray set is thus provided with two, three or four spray units in mutually adjacent orientation. The spray units of a spray set need not necessarily lie in line, but can optionally have a staggered orientation.

The apparatus is preferably provided with suction means connected to the support structure for suctioning up cleaning agent applied to the surface. The sprayed cleaning agent and the fouling dispersed therein will thus be removed relatively rapidly and effectively from the surface, whereby no fouling residues, or hardly any, remain behind on the surface. The suction means preferably extend at least as far as the width of the surface sprayed by the spray units. The suction means are generally provided here with a suction nozzle. The suctioned-up, contaminated cleaning agent is generally guided via the suction nozzle to a separate waste container for temporary storage of the used, contaminated cleaning agent. In order to generate the suction action of the suction means, these latter are generally provided with a (vacuum) pump, the suction capacity of which can preferably be regulated.

The two-step cleaning of the surface for cleaning will generally be sufficient to clean the surface adequately. However, for cleaning of seriously contaminated surfaces, the apparatus is preferably provided with brushing means connected to the support structure for mechanically brushing the surface for cleaning. The brushing means can be of very diverse nature and design. Optionally rotatable annular brushes can for instance thus be applied. Preferably however, the brushing means are at least partially formed by one or more rotatable brush rollers. The brush roller is here preferably axially rotatable about a substantially horizontal axis. The brush roller can herein rotate, as seen in the transport direction of the support structure, in a forward direction and in a rearward direction. The rotation speed and the load exerted by the brush roller on the surface for cleaning can preferably be regulated per brush roller. At least one brush roller is preferably positioned between the front spray unit and the rear spray unit in order to further brush loose the dirt released to some extent by softening by the front spray unit before this dirt is once again sprayed intensively by the rear spray unit. In order to prevent, or at least counter, released and/or brushed-loose dirt being flung about, the spray units and the brushing means are at least partly shielded by a shielding element. The shielding element will generally be formed by a hood substantially enclosing the spray units and the brushing means on the top side.

In a preferred embodiment, the apparatus is provided with regulating means for regulating the temperature, pressure and/or the quantity of cleaning agent to be applied to the surface for cleaning. It is possible to opt for separate regulation of such parameters per spray unit in order to optimize the cleaning effect of the apparatus according to the invention.

In another preferred embodiment, the relative orientation of the spray units and the support structure can be changed. It is thus possible to displace the spray units to a position at a distance from the (underlying) surface and a position suitable for maintenance, transport or storage. The spray units are thus preferably displaceable between an active position of use, in which the spray units are adapted for spraying a surface for cleaning, and a non-active maintenance position, in which the spray units can for instance be disassembled from the support structure and then undergo maintenance operations.

The support structure can be embodied so as to be given for instance a handheld form and be operated to thus clean floors and/or walls. However, for cleaning of relatively large public traffic and pedestrian areas, such as roads, pavements and so on, the support structure is preferably formed by a motorized vehicle. The spray units and optional brushing means are herein preferably positioned in front of the vehicle, wherein the supply container for the cleaning agent is preferably stationed at the rear of the vehicle.

In another preferred embodiment, the apparatus is provided with guide means for guiding the support structure along a predefined path. The support structure optionally provided with support wheels can thus be displaced along a rail for cleaning treatment of a predefined track.

The invention also relates to a vehicle of the type stated in the preamble, characterized in that the vehicle comprises pressure-generating means for bringing the cleaning agent under pressure such that the pressure of the cleaning agent sprayed on the surface for cleaning fouled with chewing gum lies substantially between 300 and 750 bar, and that the vehicle comprises heating means for heating the cleaning agent such that the temperature of the cleaning agent sprayed on the surface for cleaning fouled with chewing gum amounts to a minimum of 115 degrees Celsius. The vehicle according to the invention comprises the apparatus according to the invention. Advantages of the vehicle according to the invention and possible preferred embodiments have already been described at length in the foregoing.

The invention further relates to a method for cleaning surfaces using such an apparatus, comprising the steps of: a) causing displacement of the support structure, b) heating a cleaning agent to a temperature of at least 115 degrees Celsius, c) spraying a part-surface at least once, but preferably a number of times, with the heated cleaning agent under pressure using at least one front spray unit, and d) spraying the same part-surface at least once, but preferably a number of times, with the heated cleaning agent under pressure using at least one rear spray unit, wherein the pressure of the heated cleaning agent during spraying on the surface as according to step c) and step d) lies substantially between 300 and 750 bar. The cleaning agent is preferably sprayed by the front spray unit and/or the rear spray unit onto the part-surface at a pressure of at least 300 bar. The cleaning agent sprayed by the front spray unit and/or the rear spray unit in the direction of the surface for cleaning preferably also has a temperature of at least 120 degrees Celsius, and more preferably at least 150 degrees Celsius. The cleaning effect of the apparatus according to the invention can be considerably enhanced by spraying heated cleaning agent as hot liquid or even as steam onto the contaminated surface. The cleaning capacity of the apparatus can be optimized by spraying the relatively hot cleaning agent at an increased pressure of preferably at least 300, and more preferably at least 500, bar against the surface for cleaning. This pressure preferably remains below 750 bar so as to prevent possible (undesirable) damage to the surface for cleaning. Further advantages of the method according to the invention have already been described at length in the foregoing.

The invention will be elucidated on the basis of non-limitative exemplary embodiments shown in the following figures, in which:

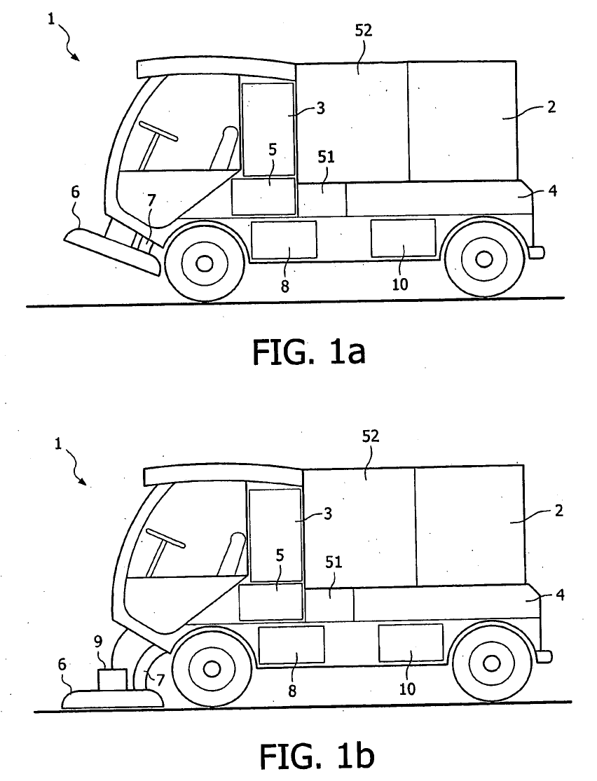

FIG. 1a shows a side view of a cleaning vehicle according to the invention in a non-active situation,

FIG. 1b shows a side view of the cleaning vehicle of FIG. 1a in an active situation,

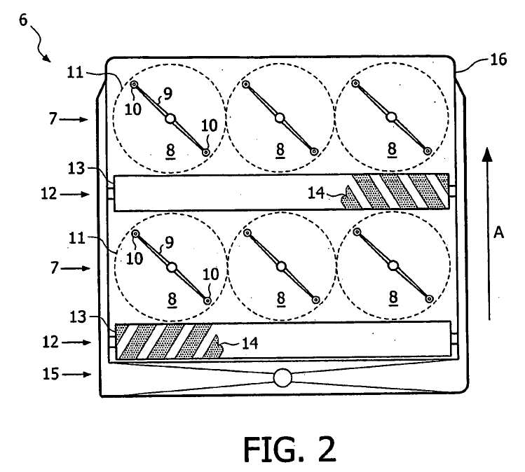

FIG. 2 shows a detailed top view of a cleaning head of the cleaning vehicle of FIGS. 1a and 1b,

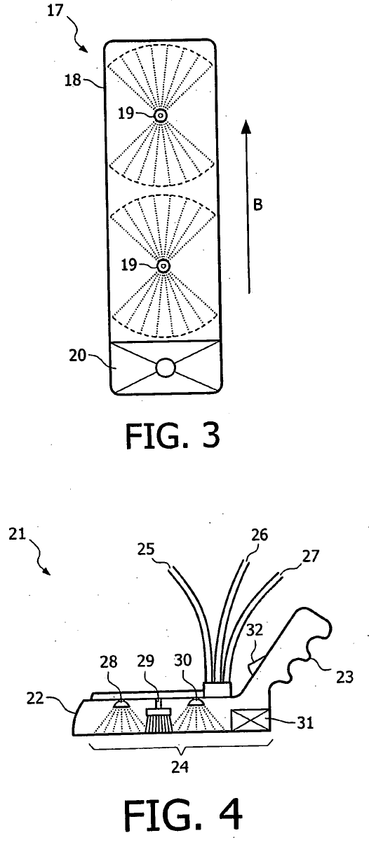

FIG. 3 shows a detailed top view of another cleaning head for use in an apparatus according to the invention,

FIG. 4 shows a cross-section of a handheld apparatus for cleaning surfaces according to the invention,

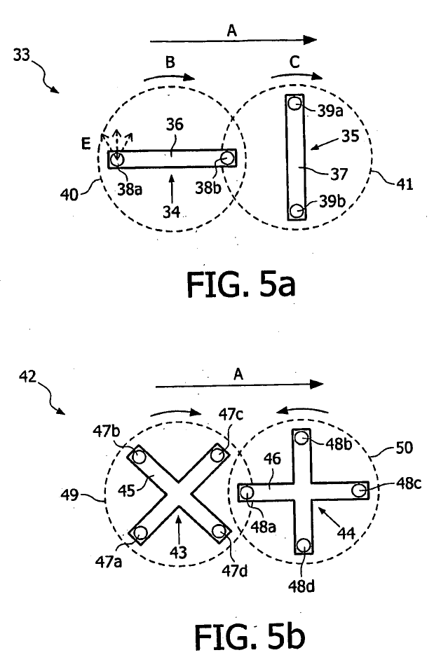

FIG. 5a shows a top view of a set of spray units for use in an apparatus according to the invention, and

FIG. 5b shows a top view of another set of spray units for use in an apparatus according to the invention.

FIG. 1a shows a side view of a cleaning vehicle 1 according to the invention in a non-active situation. Vehicle 1 comprises a water tank 2 filled with clean water and a heat exchanger 3 coupled to water tank 2 for heating water from water tank 2. Vehicle 1 is provided with a fuel supply 4 with which the water can generally be heated continuously for a full working day. Vehicle 1 also comprises a pump 5 for pumping heated clean water under pressure to a cleaning head 6 connected to vehicle 1. Via cleaning head 6 the heated water can be sprayed against a surface for cleaning. The pump pressure can herein be varied, although a pressure of above 310 bar, such as for instance 350, 400 or 500 bar is preferably applied to spray the heated water against the surface. The temperature of the water leaving cleaning head 6 will generally be above 120, and preferably above 150 degrees Celsius. A substantial part of the water will therefore be sprayed out of cleaning head 6 as steam. It is noted that a detailed view of cleaning head 6 is shown in FIG. 2. Cleaning head 6 is shown in the shown exemplary embodiment in a retracted, non-active position. In this position it will generally not be possible to utilize the cleaning head 6 for cleaning surfaces, but maintenance to cleaning head 6 can for instance be carried out, or it is made possible to displace the vehicle over a relatively long distance at a relatively high speed. FIG. 1b shows that cleaning head 6 is displaced downward to an active position in which cleaning head 6 can be utilized for cleaning an underlying surface. Heated water is sprayed in particular manner via pump 5 against the surface, whereafter possible fouling residues can be released from the surface. The mixture of water and fouling residues left behind can further be suctioned up by means of a vacuum pump 51 via a suction conduit 7 in the direction of a dirt filter 8, whereafter the filtered water can be guided to a water tank 52 filled with waste water. In an alternative embodiment, the filtered waste water is fed back to water tank 2 to be reused for cleaning the surface. The water can thus be recycled continuously, whereby the efficiency of the system is further increased and the environmental impact minimized. Cleaning head 6 is provided with a plurality of spray units (see FIG. 2) and a distribution element 9 for distributing the water flow as desired over the spray units. Distribution element 9 is herein coupled to a control unit 10 to enable regulation of the pressure and water flow rate per spray unit.

FIG. 2 shows a detailed top view of cleaning head 6 of cleaning vehicle 1 as according to FIGS. 1a and 1b. Cleaning head 6 comprises two spray sets 7 of three spray units 8 which are placed one behind the other and which are connected rotatably to vehicle 1. Each spray unit 8 is in fact formed here by a rotor 9 which is provided on opposite sides with two spray nozzles 10 extending in opposite directions. Rotors 9 can be driven electromechanically, preferably hydraulically, although it is also possible to envisage causing the rotors 9 to rotate as a result of a water power generated during spraying. Broken lines 11 indicate that each spray unit 8 can generate a circular spray pattern to enable maximizing of the surface area for cleaning. The usual direction of displacement of vehicle 1, and therefore of cleaning head 6, is indicated by means of arrow A. Cleaning head 6 is also provided with two axially rotatable brush rollers 12, of which a front brush roller 12 is positioned between the two spray sets 7 and the rear brush roller 11 is positioned behind the two spray sets 7. Each brush roller 12 is herein constructed from a cylinder 13 around which a helical brush layer 14 is arranged, only part of which is shown here. In addition to a helical brush layer 14, other types of brush layer and/or bristle pattern can also be applied to cover brush roller 12. A substantial part of spray sets 7 and brush rollers 12 are surrounded by a suction mouth 15 to enable water sprayed by spray units 8 and the released fouling residues to be suctioned up and thus leave the surface uniformly cleaned. During displacement of cleaning head 6 in the direction A the front spray set 7 will first at least partially release dirt adhered to the surface by softening. Since each spray unit 8 sprays water on the surface in a circular spray pattern, each part-surface of the surface for cleaning will twice be sprayed intensively by a single spray unit 8. The softened dirt will then be further brushed loose to some extent by the front brush roller 12. By intensively spraying the pre-cleaned surface once again via the rear spray set 7, the dirt situated on the surface will be released substantially completely. The cleaning will be further intensified and completed by the rear brush roller 11, whereafter the contaminated water is drawn up via suction mouth 15 and thus discharged. Cleaning head 6 is fully covered by a hood 16 to prevent, or at least counter, dirt being flung around.

FIG. 3 shows a detailed top view of another cleaning head 17 for use in an apparatus according to the invention. Cleaning head 17 is in fact a simplified embodiment of the cleaning head 6 shown in FIG. 2. Two spray heads 19 are arranged under a hood 18, wherein each spray head 19 is adapted to generate a fan-shaped spray pattern (shown hatched) on two sides. By displacing cleaning head 17 in the direction of arrow B, each underlying surface will in fact be sprayed four times, twice by the front spray head 19 and twice by the rear spray head 19, whereby an effective and substantially complete cleaning of a contaminated surface can be effected. The quantity of water or other liquid sprayed via spray heads 19, as well as the pressure and temperature of this water, can preferably be regulated individually per spray head 19. The water sprayed on the surface can further be discharged via a suction mouth 20.

FIG. 4 shows a cross-section of a handheld apparatus 21 for cleaning surfaces according to the invention. Apparatus 12 is provided with a support structure 22 formed by a cover provided with a handle 23, a cleaning assembly 24, and three hoses 25, 26, 27 connected to the support structure. Cleaning assembly 24 is provided with a front spray head 28 for cleaning agent, an annular rotatable brush 29 and a following rear spray head 30 for cleaning agent. Apparatus 21 is adapted for coupling via hoses 25, 26, 27 to vehicle 1 as shown in FIGS. 1a and 1b, wherein a first hose 25 is adapted to feed heated cleaning agent under pressure to spray heads 28, 30. A second hose 26 is adapted herein for hydraulic control of rotatable brush 29, and a third hose 27 is adapted to discharge used cleaning agent (provided with chewing gum residues). A suction means 31 is placed behind the rear spray head 29 in order to enable suctioning and discharge via the third hose 27 of at least a substantial part of the sprayed cleaning agent after use. The actual operation takes place via a switch 32 arranged in handle 23. The shown handheld apparatus 21 is particularly suitable for use in cleaning relatively small surfaces or surfaces difficult to access, such as (partly enclosed) floor parts or wall parts.

FIG. 5a shows a top view of a set 33 of spray units 34, 35 for use in an apparatus according to the invention. Spray units 34, 35 herein lie in line with the direction of transport (A) of apparatus 1. Each spray unit 34, 35 is formed by a centrically rotatable arm 36, 37, on the outer ends of which nozzles 38a, 38b, 39a, 39b are arranged. The axes of the two spray units 34, 35 are substantially perpendicular to each other, wherein the spray units 34, 35 in this exemplary embodiment are adapted for rotation in the same direction (see arrows B and C). Spray units 34, 35 are each adapted to spray an underlying surface in a circular spray pattern 40, 41, wherein spray patterns 40, 41 partially overlap each other. This overlap is limited by a required minimum distance between the two arms 36, 37. In this way the same part-surface, at normal speed of displacement of the apparatus, can be sprayed more than once. Nozzles 38a, 38b, 39a, 39b of spray units 34, 35 are herein oriented such that the cleaning agent leaves nozzles 38a, 38b, 39a, 39b in a direction substantially corresponding with the direction of displacement of nozzles 38a, 38b, 39a, 39b (see for instance pattern E).

FIG. 5b shows a top view of another set 42 of spray units 43, 44 for use in an apparatus according to the invention. Each spray unit 43, 44 is herein formed by a cross-shaped structure 45, 46, wherein four outer ends of each support structure 45, 46 are provided with nozzles 47a, 47b, 47c, 47d, 48a, 48b, 48c, 48d. Spray units 43, 44 are adapted to realize a substantially circular spray pattern 49, 50. Because spray units 43, 44 engage partly in each other, a certain overlap of spray patterns 49, 50 will be realized. In the shown exemplary embodiment, set 42 of spray units 43, 44 lies in line with the direction of displacement of apparatus (see arrow A), and the two spray units 43, 44 rotate in mutually opposite directions (see arrows B and C).

It will be apparent that the invention is not limited to the exemplary embodiments shown and described here, but that within the scope of the appended claims numerous variants are possible which will be self-evident to the skilled person in this field.

1-17. (canceled)

18. An apparatus for cleaning surfaces fouled with chewing gum, comprising a mobile support structure for:
at least one supply container for cleaning agent,
a plurality of spray units coupled to the supply container for spraying with the cleaning agent a surface for cleaning fouled with chewing gum, wherein each spray unit is adapted to spray the same part-surface at least once during displacement of the support structure, and
at least one pump for feeding cleaning agent under pressure to at least one spray unit,
wherein at least a front spray unit, as seen in the direction of displacement of the support structure, lies at least substantially in front of another, rear spray unit,
and further wherein
the apparatus comprises pressure-generating means for bringing the cleaning agent under pressure such that the pressure of the cleaning agent sprayed on the surface for cleaning fouled with chewing gum lies substantially between 300 and 750 bar, and that the apparatus comprises heating means for heating the cleaning agent such that the temperature of the cleaning agent sprayed on the surface for cleaning fouled with chewing gum amounts to a minimum of 115 degrees Celsius.

19. The apparatus as claimed in claim 18, wherein at least some of the number of spray units is adapted to spray the surface for cleaning in a substantially circular spray pattern.

20. The apparatus as claimed in claim 18, wherein the spray units are connected rotatably to the support structure.

21. The apparatus as claimed in claim 18, wherein the apparatus is provided with at least two spray sets, each provided with at least two spray units, wherein the spray sets, as seen in the direction of displacement of the support structure, are positioned one behind the other.

22. The apparatus as claimed in claim 18, wherein the apparatus is provided with suction means connected to the support structure for suctioning up cleaning agent applied to the surface.

23. The apparatus as claimed in claim 18, wherein the apparatus is provided with brushing means connected to the support structure for brushing the surface for cleaning.

24. The apparatus as claimed in claim 23, wherein the brushing means are at least partially formed by at least one brush roller.

25. The apparatus as claimed in claim 24, wherein at least one brush roller is positioned between the front spray unit and the rear spray unit.

26. The apparatus as claimed in claim 23, wherein the spray units and the brush means are at least partially shielded by a shielding element.

27. The apparatus as claimed in claim 18, wherein the apparatus is provided with regulating means for regulating the temperature, pressure and/or the quantity of cleaning agent to be applied to the surface for cleaning.

28. The apparatus as claimed in claim 18, wherein the relative orientation of the spray units and the support structure can be changed.

29. The apparatus as claimed in claim 18, wherein the support structure is formed by a vehicle.

30. The apparatus as claimed in claim 18, wherein the apparatus is provided with guide means for guiding the support structure in a predefined path.

31. A vehicle for cleaning surfaces fouled with chewing gum, wherein the vehicle is provided with at least one supply container for cleaning agent, a plurality of spray units for spraying with the cleaning agent a surface for cleaning fouled with chewing gum, wherein each spray unit is adapted to spray the same part-surface at least once during displacement of the support structure, and at least one pump for feeding cleaning agent taken up from the supply container under pressure to at least one spray unit, wherein at least a front spray unit, as seen in the direction of displacement of the support structure, lies at least substantially in front of another, rear spray unit,
and further wherein
the vehicle comprises pressure-generating means for bringing the cleaning agent under pressure such that the pressure of the cleaning agent sprayed on the surface for cleaning fouled with chewing gum lies substantially between 300 and 750 bar, and that the vehicle comprises heating means for heating the cleaning agent such that the temperature of the cleaning agent sprayed on the surface for cleaning fouled with chewing gum amounts to a minimum of 115 degrees Celsius.

32. A method for cleaning surfaces fouled with chewing gum, comprising the steps of:
a) causing displacement of a support structure having at least one front spray unit and at least one rear spray unit,
b) heating a cleaning agent to a temperature of at least 115 degrees Celsius,
c) spraying a part-surface at least once with the heated cleaning agent under pressure using said at least one front spray unit, and
d) spraying the same part-surface at least once with the heated cleaning agent under pressure using said at least one rear spray unit,
wherein the pressure of the heated cleaning agent during spray on the surface as according to step c) and step d) lies substantially between 300 and 750 bar.

33. The method as claimed in claim 32, wherein the cleaning agent is sprayed by the front spray unit and/or the rear spray unit onto the part-surface at a pressure of at least 310 bar.

34. The method as claimed in claim 32, wherein the cleaning agent sprayed by the front spray unit and/or the rear spray unit in the direction of the surface for cleaning has a temperature of at least 120 degrees Celsius, and preferably at least 150 degrees Celsius.
